(19) United States
(12) Patent Application Publication
(10) Pub. No.: US 2015/0301601 A1
(43) Pub. Date: Oct. 22, 2015

(54) OPERATING DEVICE FOR CONTROLLING A MEDICAL APPARATUS

(71) Applicant: Maquet GmbH, Rastatt (DE)

(72) Inventors: Bastian Ibach, Karlsruhe (DE); Tim Golde, Karlsruhe (DE); Michael Bernhart, Ettlingen (DE)

(21) Appl. No.: 14/684,776

(22) Filed: Apr. 13, 2015

(30) Foreign Application Priority Data
Apr. 17, 2014 (DE) 10 2014 105 509.8

(51) Int. Cl. G06F 3/01; G06F 19/00

(52) U.S. Cl. CPC G06F 3/014; G06F 19/3418; G06F 3/017

(57) ABSTRACT

An operating device (10) for controlling a medical apparatus (100), comprising a device body (11) and at least one switching element (12) arranged at the device body (11) and operable by a user by pressing, wherein the medical apparatus (100) is controllable via a switching state of the switching element (12), characterized by a radio transmitter (20) included in the device body (11) and coupled to the switching element (12) for outputting a radio switching signal indicating the switching state, a radio receiver (102) provided separately from the device body (11) and coupleable to the medical apparatus (100) for receiving the radio switching signal output by the radio transmitter (20), and an energy supply unit (16) for supplying at least the device body (11) with energy, wherein the device body (11) comprises a means for being attached to a hand and/or an arm of the user.

### CROSS REFERENCE TO RELATED APPLICATIONS

Applicant hereby claims foreign priority benefits under U.S.C. §119 from German Utility Model Application No. DE 10 2014 105 509.8 filed on Apr. 17, 2014, the contents of which are incorporated by reference herein.

### TECHNICAL FIELD

The invention relates to an operating device for controlling a medical apparatus, comprising a device body and at least one switching element arranged at the device body and operable by a user by pressing, wherein the medical apparatus is controllable via a switching state of the switching element.

### BACKGROUND

In surgery, an operator in many cases uses medical apparatuses which support him during surgery. As an example for this an assistance system is to be mentioned, which allows for tracking of an imaging endoscope during laparoscopic surgery.

In order to operate such a medical apparatus, the operator working under sterile conditions has to give control commands to the apparatus in order to initiate the desired actions. This happens for example by means of a switching element, which the operator presses with a finger.

For performing the surgery the operator works with different surgical instruments, which he changes in the course of the surgery. To be able to operate the medical apparatus during surgery as well, the operator has to be given a possibility for interaction with the apparatus without him having to put down his surgical instruments for this and thus being limited or impeded in his surgical activity.

In principle, it is possible to fix a switching element at the surgical or laparoscopic element itself, so that the operator can operate the medical apparatus with a finger of the hand which also holds the instrument. With respect hereto, it is exemplarily referred to Documents DE 10 2009 018 918 A1 and EP 1 937 177 A1, wherein operating devices are described which can be attached to laparoscopic instruments in order to control an assistance system for endoscope tracking.

A disadvantage of these conventional solutions is that for each individual instrument a distinct switching element is to be provided. Thus, these solutions become technically complex and expensive.

### SUMMARY

It is the object of the invention to amend an operating device of the above-mentioned type such that it allows an operator to control a medical apparatus in a technical uncomplex and simple manner without him having to put down the respectively used surgical instrument.

The invention solves this object by a radio transmitter included in the device body and coupled to the switching element for outputting a radio switching signal indicating the switching state, a radio receiver provided separately from the device body and coupleable to the medical apparatus for receiving the radio switching signal output by the radio transmitter, and an energy supply unit for supplying at least the device body with energy, wherein the device body comprises a means for being attached to a hand and/or an arm of the user.

According to the invention the instrument body, at which the switching element is located, is formed such that the user can attach it to his hand, e.g. to a finger and/or to an arm. For example, it is possible to attach the device body to the index finger of that hand with which the user also holds the surgical instruments during a surgery. By pressing the switching element on the instrument just being used, he causes the operating device to output the radio switching signal in order to control the apparatus in accordance to this signal.

In contrast to the solutions known from prior art, the operating device according to the invention does not require anymore to remount the switching element from one instrument to another. Rather, the switching element arranged at the device body remains on the finger or the hand of the user during the entire surgery, which significantly simplifies the handling of the operating device. In the following, a switching element according to the invention shall indicate any type of operating element, which can be operated by pressing, such as e.g. a pushbutton, which returns to its starting position after pressing.

As the operating device according to the invention has a radio transmitter included in the device body and a radio receiver being separate therefrom and coupleable to the medical apparatus, additional cable connections between the operating device and the medical apparatus become redundant. Due to such a wireless radio control (RF control) of the medical apparatus, possible pitfalls are avoided. Further, the usual freedom of movement of the operator is maintained.

The operating device has an energy supply unit, which supplies at least the device body, i.e. the functional components included therein, with the energy required for the device operation. The radio receiver provided separately from the device body can also be supplied with the required energy via the medical apparatus with which it is coupled. However, it is also possible that the energy supply unit does not only supply the energy to the device body but also to the radio receiver. In a further alternative embodiment the radio receiver can also have a distinct energy supply, e.g. a battery.

Preferably, the radio receiver is connected to the medical apparatus via an electrical wire. The coupling of the radio receiver to the medical apparatus is also possible in another manner, e.g. via an optical fiber or via radio (RF).

The operating device preferably has a control module coupled to the switching element, which includes the radio transmitter and a signal processor for generating the radio switching signal to be output by the radio transmitter. This control module can be integrated in the device body itself or be provided as separate assembly, which is connected via electrical wires to the device body.

In a preferred embodiment, the radio transmitter transmits a pairing signal to the radio receiver for a first time establishment of communication. Via the pairing signal the radio transmitter and thus the device body including the radio transmitter are identified as a device component which is allowed to communicate with the radio receiver and thus the medical apparatus coupled with the radio receiver. Thus, a secure and reliable control of the medical apparatus is possible. This is in particular true, if the device body of the operating device including the radio transmitter is designed as disposable, i.e. is disposed of after single use and replaced by a new device body, while the radio receiver coupled with the medical apparatus remains in operation over many surgeries. The pairing ensures that each device body to be newly used is first examined as to whether it is compatible with the usually re-usable radio receiver.

A particularly preferred embodiment provides a first radio-transmitting-receiving unit, which includes the radio transmitter and a further radio receiver, and a second radio-transmitting-receiving unit coupleable with the medical apparatus, which includes the radio receiver and a further radio transmitter. In this embodiment, the device body can not only transmit radio signals, but also receive such radio signals.

Preferably, the energy supply unit comprises suitable means for supplying electro-magnetic energy to the device body. This embodiment can be used for the components included in the device body to be supplied with energy in the manner of a passive RFID, which energy the device body receives e.g. via an antenna in the form of the electromagnetic radiation generating the radio signal. Thus, the energy supply can be provided by the same bidirectional radio connection by which also the radio switching signal is transmitted. However, it is also possible to provide a distinct radio connection for this.

In an alternative embodiment, supplying energy to the device body can also be carried out by means of an energy storage, e.g. a battery or an accumulator, included in the control module.

In a particularly preferred embodiment, the device body comprises a ring which can be put on a finger of the user. The ring is preferably formed such that its ring diameter can be adjusted variably. This may be realized by a correspondingly deformable ring material or a suitable adjustment device, e.g. a toothed belt, a spring assembly or the like. It is also possible to coat the inner circumferential surface of the ring with a foam layer, which distributes the pressure exerted by the ring on the finger equally to exclude e.g. circulatory disorders in the finger.

The switching element is preferably arranged on an outer circumferential surface of the ring, e.g. at a position at which the ring abuts the bottom side of the fingertip. Thus, the switching element can be operated easily.

In an alternative embodiment, the device body comprises a flat, flexible material piece of a medical plaster type having an area of adhesion, which is bondable onto the hand and/or the arm of the user. In this embodiment, the device body forms a “switching plaster”, which can be manufactured easily and cost-efficiently. For example, a biocompatible adhesive is positioned on the area of adhesion, the adhesive strength of which is determined such that the switching plaster adheres reliably on the target surface, e.g. the surface of a surgical glove or the skin of the operator. In addition, the adhesive strength shall be determined such that the switching plaster can be released without any greater impairment, e.g. without damage of the surgical glove, from the target surface. The area of adhesion is preferably formed such that the switching plaster, after it has once been removed from the target surface, can be adhered again with sufficient adhesive strength on the target surface. In an alternative embodiment, the area of adhesion, can also be realized as separate adhesive tape, which is coated on both sides with an adhesive and is adhered with one side on the device body and with the other side on the hand of the operator for use.

In a further alternative embodiment, the device body comprises a cover at least partially surrounding the hand of the user. At this cover, which the user slips over the hand, the switching element is positioned. Preferably, the cover is positioned at the hand, with which the user also holds the surgical instrument. Thus, the user can press the switching element on the instrument just being used in order to control the medical apparatus.

The cover according to the invention can for example be formed in the shape of a thimble, which only covers the last phalanx, two phalanxes or the entire finger. The cover can also be designed such that it covers several or all fingers of a hand in the manner of a glove.

The cover consists preferably of an elastic material, which adapts to the finger or hand shape when the operator puts the cover on. For this, in particular materials are suitable which are also used for surgery gloves. Due to its elasticity, the cover adapts well to the individual finger or hand shape of the operator. Therefore, despite of individually different hand and finger sizes, it will usually be sufficient to keep the cover at hand in only one standard size or at least in only few sizes.

The cover can be worn under or over the sterile surgical glove, which the operator uses during surgery. However, due to reasons of ergonomics and usability it seems to be advantageous to wear the cover over the surgical glove. The elasticity of the cover allows it to be fitted in a crease-free and tight manner to the finger or hand of the operator without limiting the freedom of movement significantly.

Preferably, the switching element is arranged at a position of the cover at which a fingertip of the operator is located. Thus, it is possible to operate the switching element directly with the fingertip, which makes handling of the operating device particularly easy.

The switching element is for example designed as microswitch/micro key, i.e. as electric switch/electric key, the switching contacts of which only have a slight distance of a few millimeters with respect to each other in the open state. Such a microswitch/micro key is in particular suited for the switching of small loads and thus for the generation of a switching signal according to the invention. Due to the small switching contact distance the microswitch/micro key can be operated in a particularly easy manner. Thereby, it communicates a tactile perception to the operator, which shows the operator, when the switching signal has been generated by his pressing the switching element.

The switching element can also be designed as pushbutton switch with two switch steps, a first switch step thereof being operable by pressing the pushbutton switch up to a predetermined first pushbutton travel and a second switch step thereof being operable by further pressing the pushbutton switch starting from the first switch step up to a predetermined second pushbutton travel. The pushbutton switch is preferably designed such that each switch step communicates a distinct tactile perception to the operator, which indicates reaching of the respective switch step. By providing two distinguishable switch steps two different switching signals can be generated, one of which is associated to the first and the other one is associated to the second switch step. If, however, only a single switching signal shall be generated, the provision of two switch steps provides the possibility to increase the first-fault security, as in case of failure of one of the two switch steps, the respective other switch step is still available for generating the switching signal and it thus does not lead to the failure of the system.

In a specific embodiment, the device body is formed in one piece, so that all components of the operating device, with the exception of the separate radio receiver, are integrated in the device body. This is in particular true for the control module coupled with the switching element. Alternatively the device body may be formed from two separate parts, electrically connectable via a wire structure, one of which parts includes the switching element and the other one includes the control module. This embodiment has the advantage that the part holding the switching element can be manufactured particularly small and thus does not restrict the operator during gripping and manipulating of the instruments and the tissue structures to be treated.

In a possible embodiment, the part of the device body including the control module is designed as elastic bangle. Said bangle can be attached in the region of the wrist, at the forearm or at the upper arm of the operator. Instead of an elastic bangle also a Velcro strip can be used at which the control module is attached.

Preferably, the cover includes a wire structure for the electrical connection of the switching element with the control unit. The wire structure comprises for example one or more micro cables. In order to connect the wire structure included in the cover electrically with the control module, for example a plug connection is provided, which is formed from one or more plugs attached to the end of the wire structure and one or more sockets mounted on the control unit.

In order to guarantee the elasticity of the cover, also the wire structure integrated in the cover is preferably designed elastically. This can for example be achieved by a meander-shaped arrangement of the micro cables forming the wire structure.

In a particularly preferred embodiment, the operating device has a sensor assembly for detecting the switching element within a predetermined activation zone, wherein the output of the radio switching signal by the switching element to the medical apparatus is enabled, if the sensor assembly detects the switching element within the activation zone, and the output of the radio switching signal by the switching element to the medical apparatus is blocked, if the sensor assembly does not detect the switching element within the activation zone.

In principle, it is possible to operate the switching element according to the invention only by pressing it onto an arbitrary position which provides a sufficient resistance for triggering the switching element. However, in this case an unintended operation of the switching element is likely to occur, e.g. if the operator touches accidentally with his finger, at which the switching element is positioned, the surgical instrument or another object. The above-mentioned sensor assembly now ensures that the switching element is only activated for the output of the radio switching signal to the medical apparatus, if the sensor assembly detects the switching element within a predetermined activation zone. Outside of this activation zone the key function of the switching element is deactivated. The sensor assembly can operate according to an arbitrary functional principle provided that it detects the switching element within the activation zone, so that the switching element is activated only there.

For example, a mechanically operating sensor assembly has a first form closure part arranged at the switching element and a second form closure part positionable within the activation zone, wherein the switching element is operable by pressing for outputting the radio switching signal, when the first form closure part and the second form closure part engage. Such a sensor assembly works according to a lock-and-key principle, in which one of the two form closure parts forms quasi the key and the other one the lock. Thus, for example the second form closure part can be attached to the surgical instrument. In this case, the position at which the second form closure part is located, forms the activation zone. Only if the operator moves the switching element to this position and engages the two form closure parts there, the switching element is activated. An accidental operation of the switching element is thus largely excluded.

Preferably, the switching element has a push button, which is arranged in a sunk-in manner within one of the ring elements forming the first form closure part. In this case, the second form closure part has a raised counter piece which engages the ring element for applying pressure to the push button. In this embodiment, it is ensured that the push button is only operated, if the ring element forming the first form-closure part is put positively on the raised counter piece, which then positively abuts the inner circumferential surface of the ring element.

In an alternative embodiment, the sensor assembly comprises a magnetic switch. This magnetic switch is formed from an element switchable by a magnetic field and an element generating the magnetic field. One of the elements forming the magnetic switch is arranged at the switching element, while the other element is positionable within the activation zone. For example, it is possible to attach a magnet to the medical instrument. If the operator moves the magnetically switchable element arranged at the cover in a region surrounding the magnet, the magnetic field generated by the magnet acts on the switchable element causing it to be activated. If the switching element is operated by pressing in this activated state, the generated control signal is transmitted to the medical apparatus. If, in contrast, the switching element is pressed, while it is in a region in which the magnetic field does not act on the magnetically switchable element, the transmission of the control signal to the medical apparatus is blocked.

The magnetically switchable element is for example a reed-switch or a Hall sensor.

Further, the invention relates to a method for providing an operating device for controlling a medical apparatus according to independent claim 22.

In this method, preferably a disposable is manufactured. For this, in particular one of the above-described embodiments such as a switching plaster or a ring may be used.

### BRIEF DESCRIPTION OF THE DRAWINGS

The invention will be explained in more detail in the following on the basis of the Figures, wherein:

FIG. 1 shows an operating device according to the invention for controlling a medical apparatus as block diagram,

FIG. 2 shows a schematic illustration of the operating device according to FIG. 1 when a switching plaster is used as device body,

FIG. 3 shows a modification of the operating device according to FIG. 1 as block diagram,

FIG. 4 shows a schematic illustration of the operating device according to FIG. 3 when a switching plaster is used as device body,

FIG. 5 shows a schematic illustration showing different suitable positions, in which the switching plaster can be attached to the hand of the user,

FIG. 6 shows a further embodiment of the operating device according to the invention, in which the device body is formed by an integral elastic ring,

FIG. 7 shows a schematic illustration of a pushbutton switch with two switch steps, which constitutes an exemplary embodiment of the switching element according to the invention,

FIG. 8 shows a further embodiment of the operating device, in which the two-part device body is formed from an elastic cover and a bangle,

FIG. 9 shows the operating device according to FIG. 8 in a further schematic illustration,

FIG. 10 shows a modification of the embodiment shown in FIG. 8, in which a mechanical sensor assembly is used,

FIG. 11 shows the operating device according to FIG. 10 in a further schematic illustration,

FIG. 12 shows a further modification of the embodiment shown in FIG. 8, in which a magnetic sensor assembly is used, and

FIG. 13 shows the operating device according to FIG. 12 in a further schematic illustration.

### DETAILED DESCRIPTION

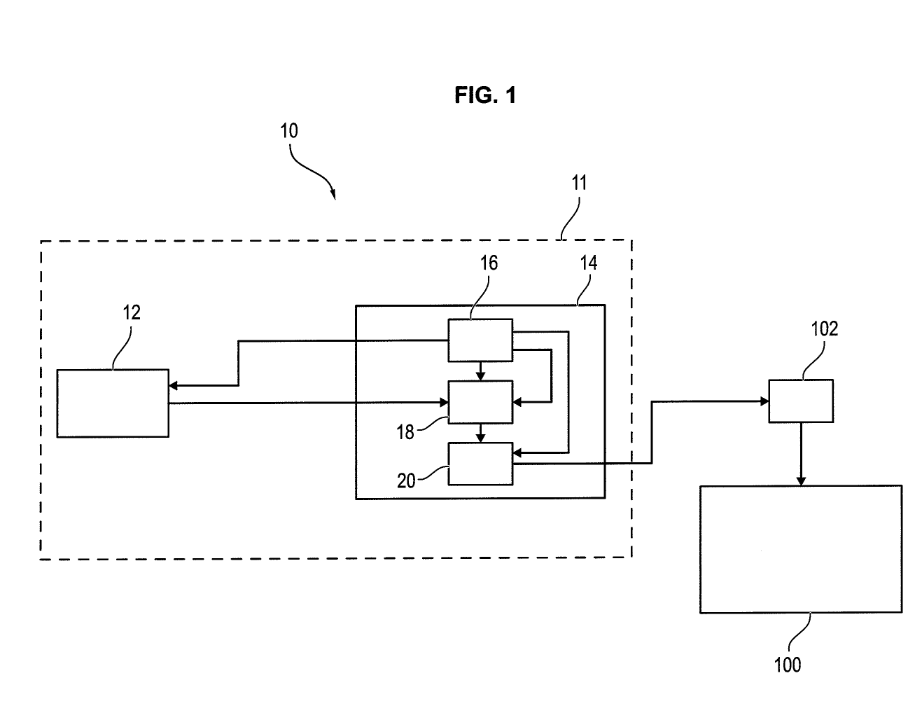

FIG. 1 shows the operating device 10 according to the invention in a block diagram.

The operating device 10 has a pushbutton 12 as switching element, which an operator can press for operating the operating device 10. The operating device 10 further comprises a control module 14 coupled to the pushbutton 12, which control module 14 includes a battery 16 as energy storage, a signal processor 18 and a radio transmitter 20. In the embodiment according to FIG. 1, the pushbutton 12 and the control module 14 are integrated in a one-piece device body 11. As will be later described in detail, it is however also possible to provide a two-piece device body, wherein at one part of such a device body the pushbutton 12 is arranged, while the other part of the device body includes the control module 14.

The operating device 10 further has a radio receiver 102, which is e.g. coupled via an electric wire with a medical apparatus 100. The apparatus 100 is for example an imaging assistance system, which tracks an endoscope equipped with a camera during a laparoscopic surgery. The radio receiver 102 forms an assembly separate from the device body 11.

The battery 16 included in the control module 14 supplies electro-magnetic energy both to the components also included in the control module 14, namely the signal processor 18 and the radio transmitter 20, as well as to the pushbutton 12 coupled to the control module 14. The signal processor 18 receives an operation signal, which the pushbutton 12 outputs to the control module 14, when the operator operates the pushbutton 12 by pressing. This operation signal indicates the switching state of the pushbutton 12. The signal processor 18 converts the operation signal received from the pushbutton 12 and outputs it to the radio transmitter 20. The radio transmitter 20 transmits the radio switching signal generated by the signal processor 18 to the radio receiver 102 which is coupled to the medical apparatus 100. As a consequence, in the apparatus 100 an action is initiated corresponding to the received radio switching signal, e.g. an automatic tracking of an endoscope directed to the surgical site.

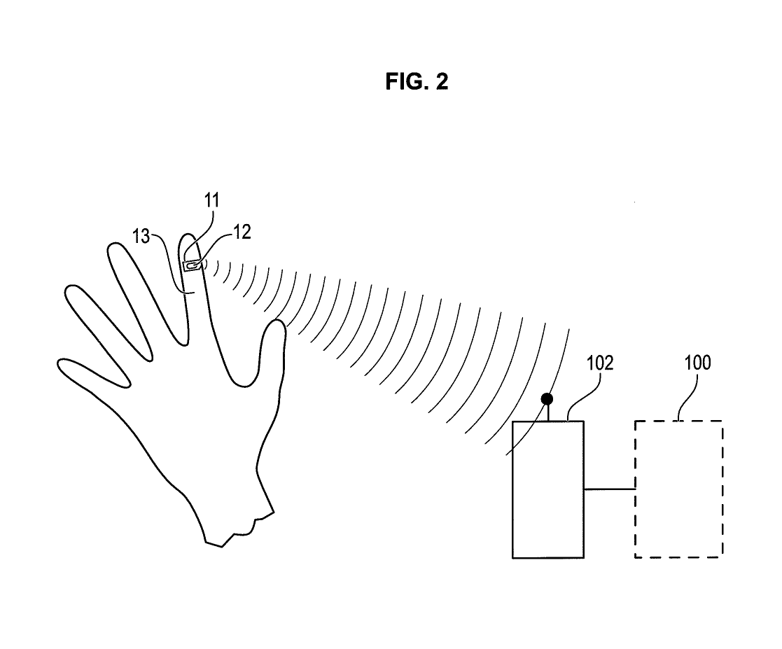

In FIG. 2, an embodiment is schematically shown, which operates according to the functional principle shown in FIG. 1. In the embodiment according to FIG. 2, a one-piece device body 11 is formed from a switching plaster, i.e. from a flat, flexible material piece, which is bondable like a medical plaster. In the present embodiment, the switching plaster 11 is directly bonded onto the skin of a finger 13 or onto a surgical glove, which the operator wears during surgery. FIG. 2 illustrates how the switching plaster 11 transmits the radio switching signal to the radio receiver 102. In the embodiment according to FIG. 2, the switching plaster 11 is supplied by the battery 16 shown in FIG. 1, which is integrated in the switching plaster 11.

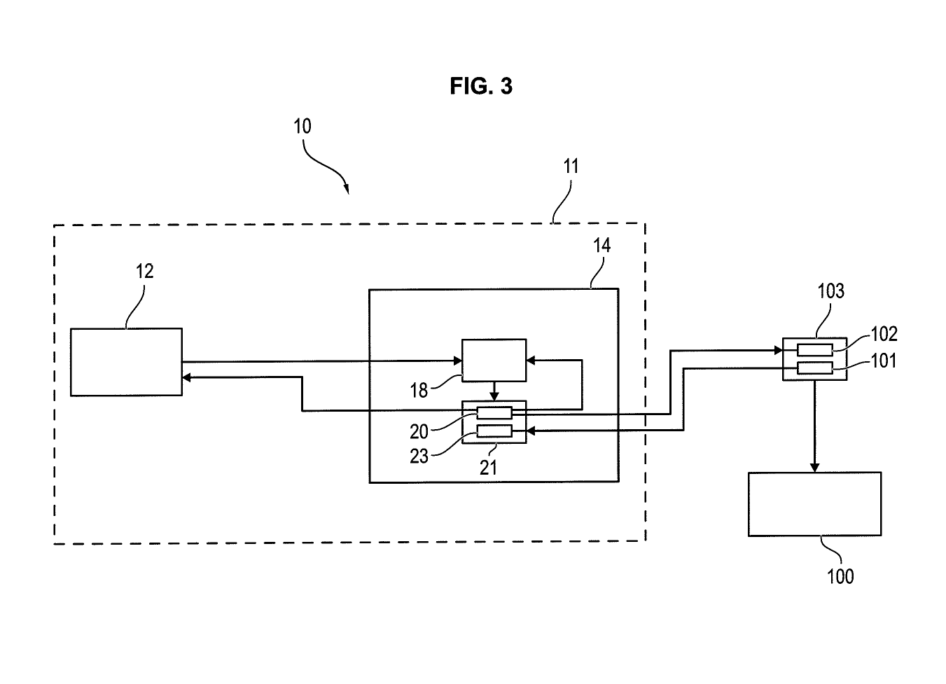

FIG. 3 shows an embodiment of the operating device 10 which is modified with respect to the embodiment according to FIG. 1 in that the device body 11 is not supplied via a battery, but in the manner of a passive RFID element via an externally supplied radio signal. For this, a further radio transmitter 101 is provided, which is part of a separate radio-transmitting-receiving unit 103, coupleable to the medical apparatus 100, which radio-transmitting-receiving unit 103 also includes the radio receiver 102. Correspondingly, the control module 14 arranged in the device body 11 includes a radio-transmitting-receiving unit 21, which includes in addition to the radio transmitter 20 a further radio receiver 23. In order to supply energy to the device body 11, the radio receiver 23 absorbs the energy, which the radio transmitter 101 emits in the form of a radio signal. This absorbed radio energy is then converted into electric energy in the control module 14.

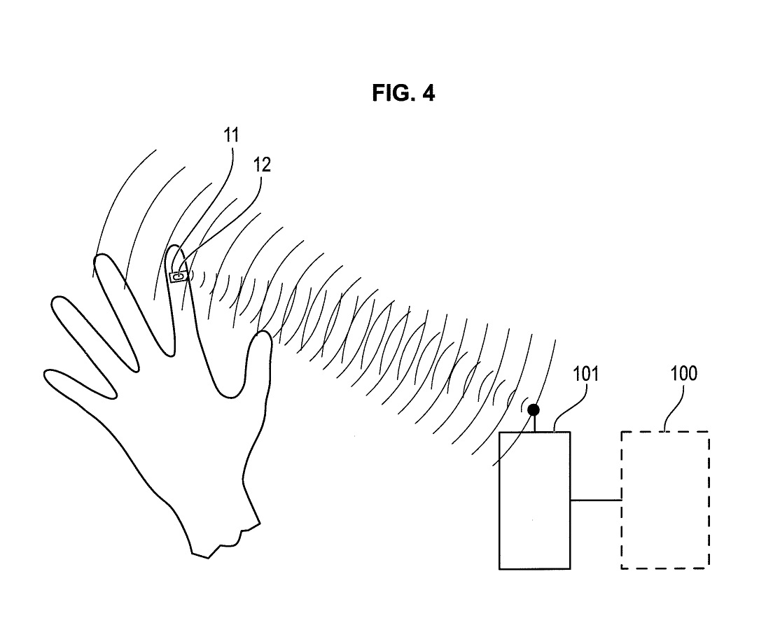

FIG. 4 illustrates the bidirectional radio communication for the embodiment according to FIG. 3. In particular, FIG. 4 shows as supplement to the embodiment illustrated in FIG. 2 how the switching plaster forming the device body 11 is supplied with energy by the radio-transmitting-receiving unit 101.

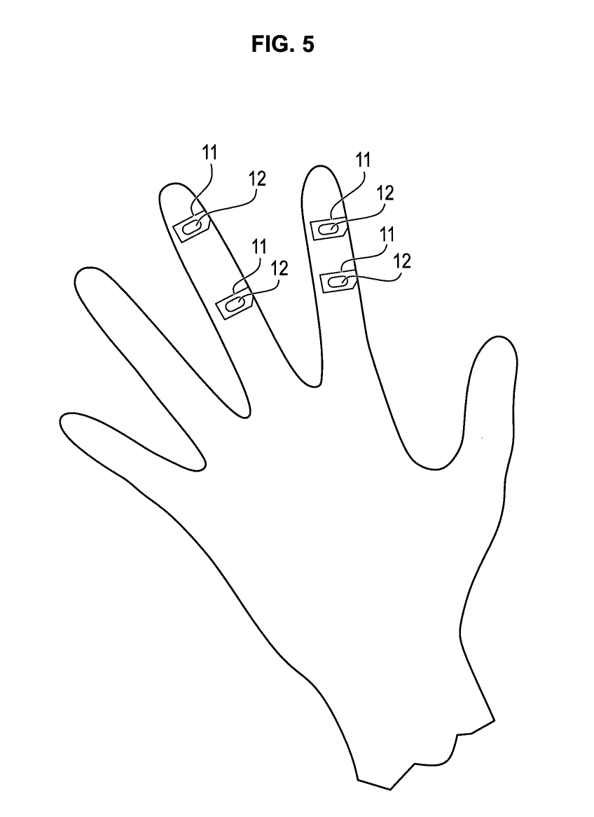

In FIG. 5 it is illustrated that the switching plaster 11, depending on requirements, is bondable onto different positions on the hand of the operator. In this context, it is to be pointed out that the invention is not limited to the use of a single switching plaster 11 (or an alternatively designed device body 11). Thus, it is also possible to attach a plurality of switching plasters 11 to the hand of the operator.

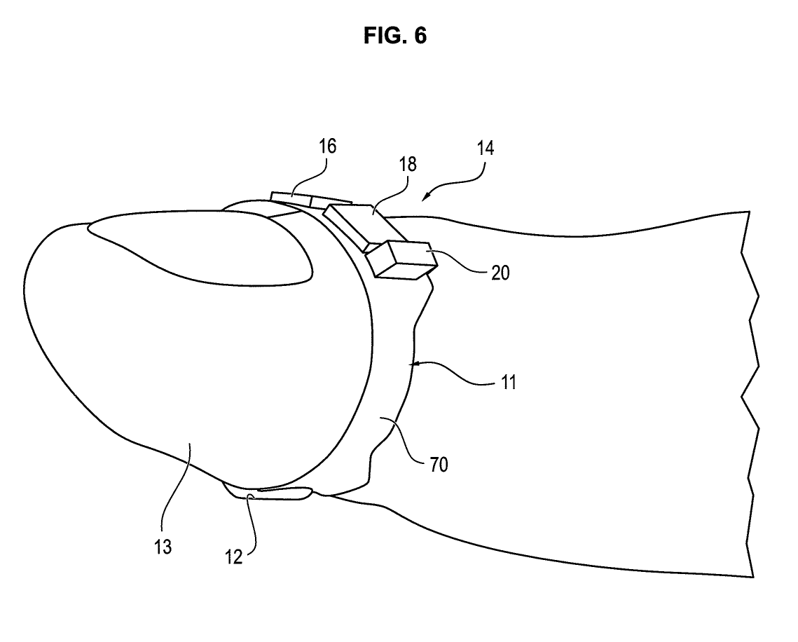

In FIG. 6, an embodiment is illustrated, in which the device body 11 is formed from an elastic ring 70, which the operator can put on his finger 13. In order to strengthen the fixation of the ring 70 to the finger 13 an adhesive may be applied to the inner circumferential surface of the ring 70. Also in this embodiment, the device body formed by the ring 70 is formed in one piece. Both the pushbutton 12 and the control module 14, which includes the battery 16, the signal processor 18 and the radio transmitter 20, are arranged on the outer circumferential surface in an angular distance of approximately 180° with respect to each other. However, it is also possible that the ring 70 only forms one part holding the switching element 12 of a two-part device body. In this case, a second part holding the control module 14 would have to be provided, which is both coupled via a wire structure (not shown) to the ring and as well coupled via radio to the radio receiver 102.

FIG. 7 shows an exemplary embodiment in which the switching element 12 is formed as pushbutton switch with two switch steps. The two switch steps are activated by operating forces of different strengths. In the specific example according to FIG. 7, if an operating force F of 2N is applied, a first pushbutton travel of 0.5 mm is generated. The reaching of this pushbutton travel is tactilely communicated by a click to the operator. If the operator then starting from the first switch step fully presses the pushbutton switch 12 with a force of 5N, a second pushbutton travel of further 0.4 mm and thus a total stroke of 0.9 mm is generated. With this pushbutton travel the second switch step is reached, which is again tactilely communicated to the operator by a click.

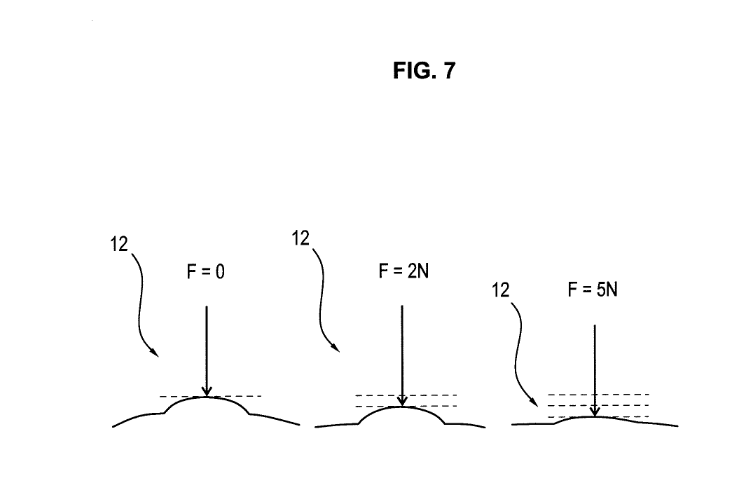

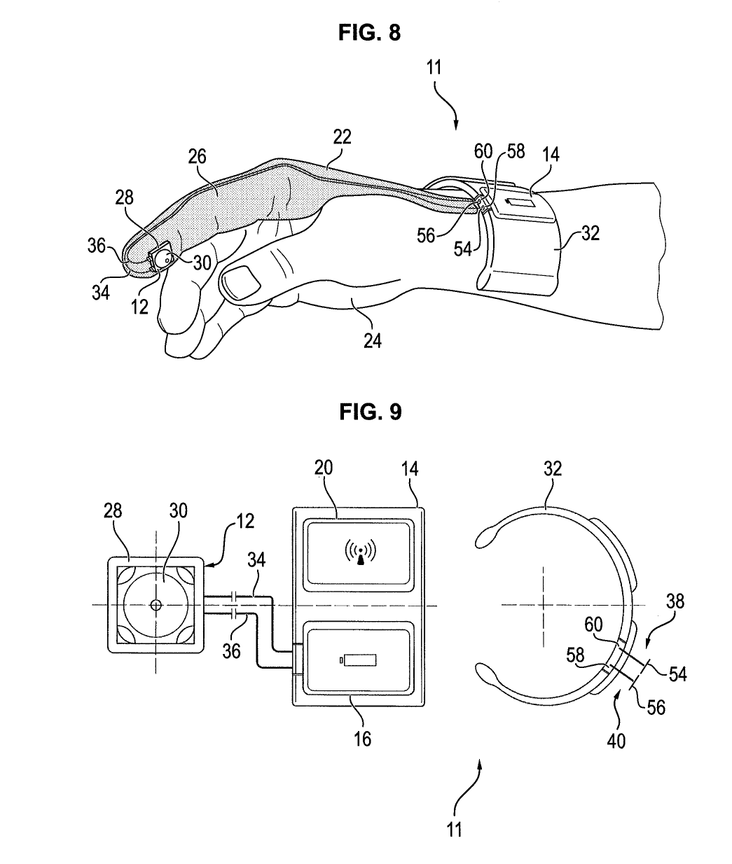

In the further embodiments according to FIGS. 8 to 13 described below, the device body 11 is formed from two separate parts coupleable to each other, namely an elastic cover 22 and a bangle 32, in contrast to the embodiments above.

The operating device 10 according to FIG. 8 includes the elastic cover 22, which is adapted to the hand of the operator indicated with 24 in FIG. 8 such that it can be pulled over an index finger 26. The pushbutton 12 is arranged at the cover 22 at a position at which it is located on the bottom side of the tip of the index finger 12, when the cover 22 is pulled on the index finger 26 of the operator. Thus, the operator can operate the pushbutton 12 with his fingertip.

The pushbutton 12 has a flat rectangular housing on which a push button is arranged, e.g. in the form of a switching membrane 30, which is deformable by pressing. By pressing the switching membrane 30, switching contacts (not explicitly shown in FIGS. 8 and 9) included in the housing 28, contact each other. By closing these switching contacts, the pushbutton 12 is prompted to output the switching signal.

The operating device 10 according to FIG. 8 further includes the elastic bangle 32, which the operator puts on the wrist. The bangle 32 carries the control module 14 electrically connected to the pushbutton 12. The pushbutton 12 and the control module 14 are connected to each other via two cables 34 and 36, which are respectively guided with one of their ends out of the housing 28 of the pushbutton 12 and coupled with their other end to the control module 14. The cables 34 and 36 are coupled to the control module 14 via two plug connectors 38 and 40 (cf. FIG. 11), which are respectively formed from a plug 54, 56 arranged at the corresponding cable 34 or 36 and a socket 58, 60 associated to said plug 54, 56, which socket 58, 60 is positioned at the control module 14. One of these two cables 34 and 36 is connected to the battery 16 inside the control module 14 and thus serves for supplying electro-magnetic energy to the pushbutton 12, while the other cable is coupled to the signal processor 18. Correspondingly, the pushbutton 12 transmits the switching signal via the other one of the two cables 34 and 36 to the signal processor 18, which switching signal is generated with operating the switching membrane 30.

In FIG. 9, once again the two-part structure of the device body 11 is illustrated.

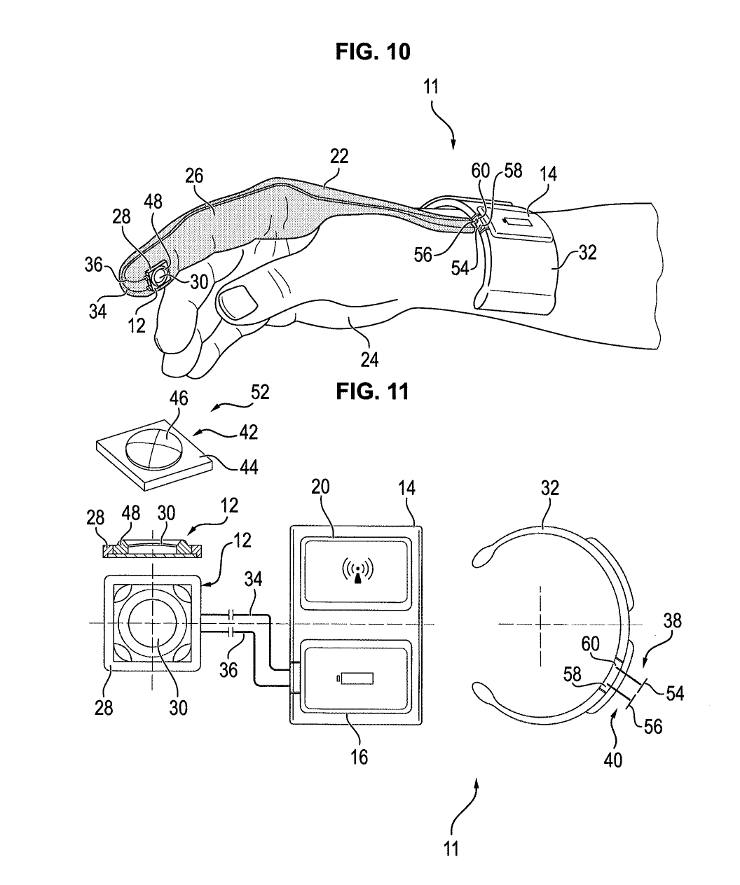

In FIGS. 10 and 11, a further embodiment of the operating device 10 is shown. This embodiment differs from the embodiment of FIG. 8 in an assembly, which allows the operator to activate the pushbutton 12 for outputting the switching signal only as required.

This assembly includes a form closure part 42 cooperating with the pushbutton 12 in a manner explained below, in order to activate said pushbutton for outputting the switching signal. The form closure part 42 comprises a plate-like element 44, on the top side of which a raised, circular counter piece 46 is arranged. The counter piece 46 is adapted with respect to shape and size to the switching membrane 30 of the pushbutton 12 such that it presses onto the switching membrane 30, when the operator positions the pushbutton element 12 onto the form closure part 42. In order to allow a positive positioning of the pushbutton 12 onto the form closure part 42 a form closure part 48, corresponding to the form closure part 42, is formed at the pushbutton 12, the form closure part being 48 being a circular ring surrounding the switching membrane 30 concentrically. If the operator presses the pushbutton 12 in an accurately fitting manner onto the form closure part 42, the ring 48 is positioned on the top side of the form closure part 42 such that it abuts the circumference of the raised counter piece 46. In this positive abutment, the counter piece 46 then presses onto the switching membrane 30 causing the switching contacts included in the housing 28 of the pushbutton 12 to be closed.

FIG. 11 also shows the pushbutton 12 provided with the ring 48 in cross section. This cross sectional view shows that the switching membrane 30 is arranged in a sunk-in manner within the ring 48. This sunk-in arrangement means that the ring 48 in cross section projects over the switching membrane 30, so that the switching membrane 30 is not operated, when the pushbutton 12 and thus the projecting ring 48 is for example positioned onto a planar or only slightly curved surface. Only if the pushbutton 12 is positioned in an accurately fitting manner onto the form closure part 42 the counter piece 46 engaging the ring 48 allows for an operation of the switching membrane 30.

Thus, the two form closure parts 42 and 48 form a sensor assembly, generally indicated with 52 in FIG. 10, which allows the pushbutton 12 to be detected in a predetermined activation zone and an output of the switching signal to the control module 14 to be enabled only, if the pushbutton 12 is in the activation zone. The activation zone is thereby defined by the location of the form closure part 42, which is for example attached on a surgical instrument.

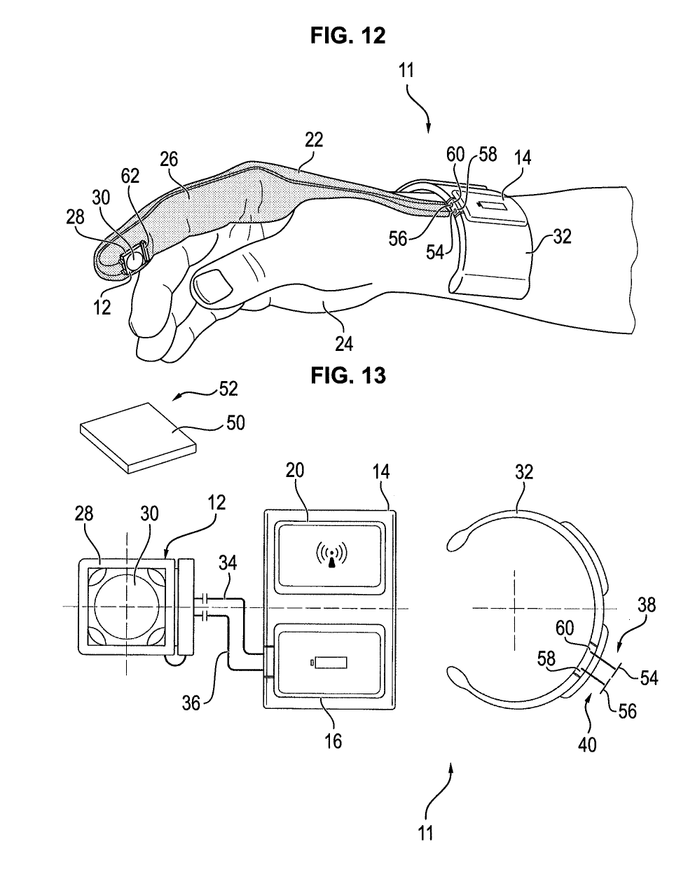

In FIGS. 12 and 13 a further embodiment is shown which differs from the embodiment according to FIGS. 10 and 11 in a different type of sensor assembly 52.

While in the embodiment according to FIGS. 10 and 11 the two form closure parts 42 and 48 quasi form a mechanically operating sensor assembly for detecting a release status of the pushbutton element 12, in this embodiment the sensor assembly is an electro-magnetically operating assembly.

The sensor assembly 52 shown in FIGS. 12 and 13 is formed from a magnetic switch, which comprises a magnetically switchable element in the form of a reed-switch 62, arranged adjacent to the housing 28 of the pushbutton 12, and a magnetic plate 50 magnetically interacting with the reed-switch 62. The magnetic plate 50 generates a magnetic field, which can be used for defining an activation zone within which the pushbutton 12 is activated for outputting the switching signal. The activation zone in turn is defined by the location of the magnetic plate 50, wherein the magnetic plate 50 is preferably attached to the surgical instrument. If the operator moves the pushbutton 12 held at its index finger 26 in the magnetic field generated by the magnetic plate 50, it acts such on the reed-switch 62 arranged at the pushbutton 12 that the reed-switch 62 is closed and thus the pushbutton 12 is activated via a corresponding signal. If the operator then presses the pushbutton 12 in the activated state with its switching membrane 30 on the magnetic plate 50, the pushbutton 12 transmits the switching signal via the radio transmitter 20 included in the control module 14 to the medical apparatus 100.

If, however, the pushbutton 12 is operated outside of the activation zone, i.e. outside of the sphere of action of the magnetic field generated by the magnetic plate 50, the output of the switching signal from the reed-switch 62 included in the pushbutton 12 is blocked. Consequently, in this state, an operation of the switching membrane 30 of the pushbutton 12 does not cause an output of the switching signal to the medical apparatus 100.

The embodiments of the sensor assembly explained above are only intended as examples. Thus, e.g. the reed-switch 62 can also be replaced by a mechanically switchable element of another type, e.g. a Hall sensor.

Generally, also sensor assemblies other than the mechanical assembly according to the embodiment shown in FIGS. 10 and 11 or the electromagnetical assembly according to the embodiment shown in FIGS. 12 and 13 can be used for detecting the pushbutton 12 in the activation zone, e.g. an assembly operating with optical means such as an illuminating diode and a photodiode. Alternatively, also a sensor assembly may be used, in which the activation zone is marked by a chemical substance and detected via a corresponding chemical sensor, which is arranged at the pushbutton 12.

The above-described embodiments are only intended for the exemplary illustration of the subject-matter of the invention. In particular, the different aspects described for the individual embodiments can be combined in a reasonable manner. This applies in particular to the concrete design of the one- or multi-part device body 11 as well as to the concrete design of the switching element 12. The same applies to the energy supply of the device body 11. Thus, for example the control module 14 shown in FIGS. 8 to 13 can also be supplied with energy externally in the manner of a passive RFID element.

What is claimed is:

1. An operating device for controlling a medical apparatus, comprising a device body and at least one switching element arranged at the device body and operable by a user by pressing, wherein the medical apparatus is controllable via a switching state of the switching element,
wherein a radio transmitter included in the device body and coupled to the switching element for outputting a radio switching signal indicating the switching state,
a radio receiver provided separately from the device body and coupleable to the medical apparatus for receiving the radio switching signal output by the radio transmitter, and
an energy supply unit for supplying at least the device body with energy, wherein
the device body comprises a means for being attached to a hand and/or an arm of the user.

2. The operating device according to claim 1, wherein a control module coupled to the switching element, which control module includes the radio transmitter and a signal processor for generating the radio switching signal to be output by the radio transmitter.

3. The operating device according to claim 1, wherein the radio transmitter transmits a pairing signal to the radio receiver for a first time establishment of communication.

4. The operating device according to claim 1, wherein a first radio-transmitting-receiving unit arranged in the device body, which first radio-transmitting-receiving unit includes the radio transmitter and a further radio receiver, and a second radio-transmitting-receiving unit coupleable to the medical apparatus, which second radio-transmitting-receiving unit includes the radio receiver and a further radio transmitter.

5. The operating device according to claim 1, wherein the energy supply unit comprises means for supplying electro-magnetic energy to the device body.

6. The operating device according to claim 1, wherein an energy storage included in the control module.

7. The operating device according to claim 1, wherein the device body comprises a ring which can be put on a finger of the user.

8. The operating device according to claim 7, wherein the ring has a means for adjusting its ring diameter.

9. The operating device according to claim 8, wherein the switching element is arranged on an outer circumferential surface of the ring.

10. The operating device according to claim 1, wherein the device body comprises a flat, flexible material piece of a medical plaster type, which has an area of adhesion bondable onto the hand and/or the arm of the user.

11. The operating device according to claim 1, wherein the device body comprises a cover at least partly surrounding the hand of the user.

12. The operating device according to claim 1, wherein the switching element is a pushbutton switch with two switch steps, a first switch step thereof being operable by pressing the pushbutton switch up to a predetermined first pushbutton travel and a second switch step thereof being operable by further pressing the pushbutton switch starting from the first switch step up to a predetermined second pushbutton travel.

13. The operating device according to claim 1, wherein the device body is formed in one piece.

14. The operating device according to claim 1, wherein the device body is formed from two separate parts, preferably electrically connectable to each other via a wire structure, one of which including the at least one switching element and the other one including the control module.

15. The operating device according to claim 14, wherein a plug connection for electrically connecting the two parts forming the device body.

16. The operating device according to claim 14 wherein the part of the device body having the control module is an elastic bangle.

17. The operating device according to claim 1, wherein a sensor assembly for detecting the switching element within a pre-determined activation zone, wherein the output of the radio switching signal by the radio transmitter is enabled, if the sensor assembly detects the switching element within the activation zone, and the output of the radio switching signal is blocked, if the sensor assembly does not detect the switching element within the activation zone.

18. The operating device according to claim 17, wherein
the sensor assembly includes a first form closure part arranged at the switching element and a second form closure part positionable within the activation zone; and
the switching element is operable by pressing for outputting the radio switching signal, when the first form closure part and the second form closure part engage.

19. The operating device according to claim 18, wherein the switching element includes a push button, which is arranged in a sunk-in manner within the first form closure part; and
the second form closure part includes a raised counter piece which engages the first form closure part for applying pressure to the push button.

20. The operating device according to claim 17, wherein the sensor assembly comprises a magnetic switch, which is formed from an element switchable by a magnetic field and an element generating the magnetic field, wherein one of the elements of the magnetic switch is arranged at the switching element and the other element is positionable within the activation zone.

21. The operating device according to claim 20, wherein the element switchable by the magnetic field is a reed-switch or a Hall sensor.

22. The operating device according to claim 1, wherein the device body is formed from a fluid-repellent material.

23. A method for providing an operating device for controlling a medical apparatus, comprising the following steps:
manufacturing of a device body provided for the operating device, which includes at least one switching element manually operable by a user by pressing, wherein the medical apparatus is controllable via a switching state of the switching element, a radio transmitter coupled to the switching element for outputting the radio switching signal indicating the switching state and a means for attaching the device body to a hand and/or an arm of the user;
sterilizing the manufactured device body; and
arranging the sterilized device body in a packaging, which is to be opened by the user for using the operating device.
